(19) United States
(12) Patent Application Publication
(10) Pub. No.: US 2019/0156978 A1
(43) Pub. Date: May 23, 2019

(54) INSULATED ELECTRICAL WIRE, COIL, AND ROTARY ELECTRIC MACHINE

(71) Applicants: DENSO CORPORATION, Kariya-city (JP); UNIMAC LTD., Inabe-shi (JP)

(72) Inventors: Akito TAMURA, Kariya-city (JP); Yuki AMANO, Kariya-city (JP); Kazuomi HIRAI, Inabe-shi (JP); Masatoshi NARITA, Inabe-shi (JP); Tatsumi HIRANO, Inabe-shi (JP); Yasunari ASHIDA, Inabe-shi (JP); Suguru IGARASHI, Inabe-shi (JP)

(73) Assignees: DENSO CORPORATION, Kariya-city (JP); UNIMAC LTD., Inabe-shi (JP)

(21) Appl. No.: 16/260,906

(22) Filed: Jan. 29, 2019

Related U.S. Application Data
(63) Continuation of application No. PCT/JP2017/027800, filed on Aug. 1, 2017.

(30) Foreign Application Priority Data
Aug. 2, 2016 (JP) 2016-152102

(51) Int. Cl. H01F 5/06; H02K 3/32; H02K 3/46

(52) U.S. Cl. CPC H01F 5/06; H02K 3/46; H02K 3/32

(57) ABSTRACT

An insulated electrical wire of an embodiment includes a conductor having a first and a second lateral face which are opposed to each other; and a first and a second insulating film which are arranged on the first and second lateral faces, respectively, and each of which has a pair of convex portions and an intermediate portion arranged between the pair of convex portions. A ratio of a thickness of the intermediate portion relative to a thickness of the pair of convex portions of each of the first and second insulating films is from 0.50 to 0.90.

### CROSS-REFERENCE TO RELATED APPLICATION

This application is the U.S. national phase of International Application No. PCT/JP2017/027800 filed Aug. 1, 2017 which designated the U.S. and claims priority to Japanese Patent Application No. 2016-152102 filed Aug. 2, 2016, the contents of which are incorporated herein by reference.

### TECHNICAL FIELD

An embodiment of the present disclosure relates to an insulated electrical wire, a coil, and a rotary electric machine.

### BACKGROUND

A rotary electric machine is used as an electric motor or a power generator, and the rotary electric machine includes a rotor (rotor fixed to a rotor shaft) and a stator (stator arranged around the rotor). The stator includes a stator core and a stator coil, and the stator applies a rotating magnetic field to the rotor. A plurality of slots are arranged in a circumferential direction of the stator core, and at least part of the stator coil is arranged in the slot.

The stator coil is formed of an insulated electrical wire having a circular section (round enameled wire) or an insulated electrical wire having a rectangular section (rectangular enameled wire). The rectangular enameled wire has a conductor (rectangular conductor) having a rectangular section and an insulating film. An insulating paint is applied around the conductor and baked to form the insulating film. Using the rectangular enameled wire, a high coil space factor can be obtained, and thus downsizing of the stator coil and further downsizing of the rotary electric machine can be achieved.

### SUMMARY

The present disclosure has been made to solve such a problem and has an object to provide an insulated electrical wiring capable of improving vibration resistance and shock resistance. Further, the present disclosure has an object to provide a coil and a rotary electric machine having such an insulated electrical wiring and having satisfactory vibration resistance and shock resistance. An insulated electrical wiring in one aspect includes a conductor having a first lateral face and a second lateral face which are facing towards each other, and a first insulating film and a second insulating film which are arranged on the first lateral face and the second lateral face, respectively, and each of which has a pair of convex portions and an intermediate portion arranged between the pair of convex portions. A ratio of a thickness of the intermediate portion relative to a thickness of the convex portion of each of the first and second insulating films is from 0.50 to 0.90.

An insulated electrical wiring of the present disclosure has an insulating film of a specific shape. This can improve vibration resistance and shock resistance.

### BRIEF DESCRIPTION OF THE DRAWINGS

In the accompanying drawings:

FIG. 1 is a sectional view showing an insulated electrical wiring of an embodiment;

FIG. 2 is a sectional view showing a laminated state of the insulated electrical wiring s shown in FIG. 1;

FIG. 3 is a sectional view showing another insulated electrical wiring of the embodiment;

FIG. 4 is a sectional view showing a rotary electric machine of the embodiment;

FIG. 5 is a plan view showing a stator core of the rotary electric machine shown in FIG. 4;

FIG. 6 is a sectional view showing a part of the stator core and a stator coil of the rotary electric machine shown in FIG. 4; and

FIG. 7 is a diagram for explaining an evaluation method of vibration resistance.

### DETAILED DESCRIPTION OF THE PREFERRED EMBODIMENTS

The inventor of the present disclosure has studied an insulated electrical wire, a coil, and a rotary electric machine.

In recent years, rotary electric machines are used in various vehicles. According to the rotary electric machine, vehicle kinetic energy can be recovered as regenerative power and acceleration of vehicle can be assisted. Further, when used together with an engine, the rotary electric machine can start the engine.

A rotary electric machine used for a vehicle is required to have favorable vibration resistance and shock resistance. To improve vibration resistance and shock resistance, for example, varnish treatment (varnish is impregnated and cured) is performed on a coil attachment unit to which the stator coil is attached in the slot of the stator core.

Specifically, varnish is impregnated into a space between the slot of the stator core and the stator coil and cured, and also varnish is impregnated into a space between the insulated electrical wirings forming the stator coil and cured. Thereby, the slot and the stator coil are fixed and the insulated electrical wirings forming the stator coil are fixed to improve vibration resistance and shock resistance.

However, in a case where a rectangular enameled wire is used for an insulated electrical wire forming a stator coil, there is a possibility that varnish is not sufficiently impregnated into a space between a slot of a stator core and the stator coil or a space between the insulated electrical wirings forming the stator coil. Hence, there is a possibility that fixation between the slot and the stator coil or fixation between the insulated electrical wirings forming the stator coil is not performed reliably. In this case, vibration resistance and shock resistance are not always improved sufficiently.

The present disclosure has been made to solve such a problem and has an object to provide an insulated electrical wiring capable of improving vibration resistance and shock resistance. Further, the present disclosure has an object to provide a coil and a rotary electric machine having such an insulated electrical wiring and having satisfactory vibration resistance and shock resistance.

Hereinafter, an embodiment of the present disclosure will be described below with reference to drawings.

Note that the present disclosure is not limited by the drawings at all.

### <Insulated Electrical Wiring>

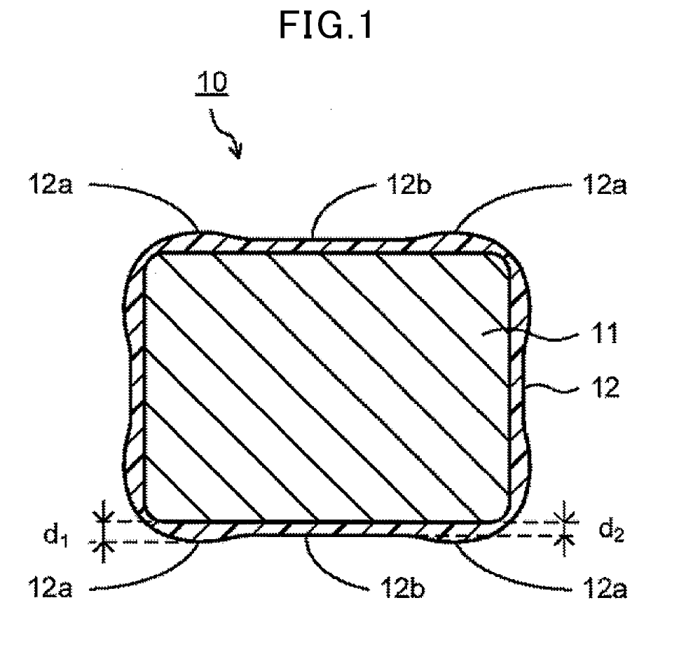

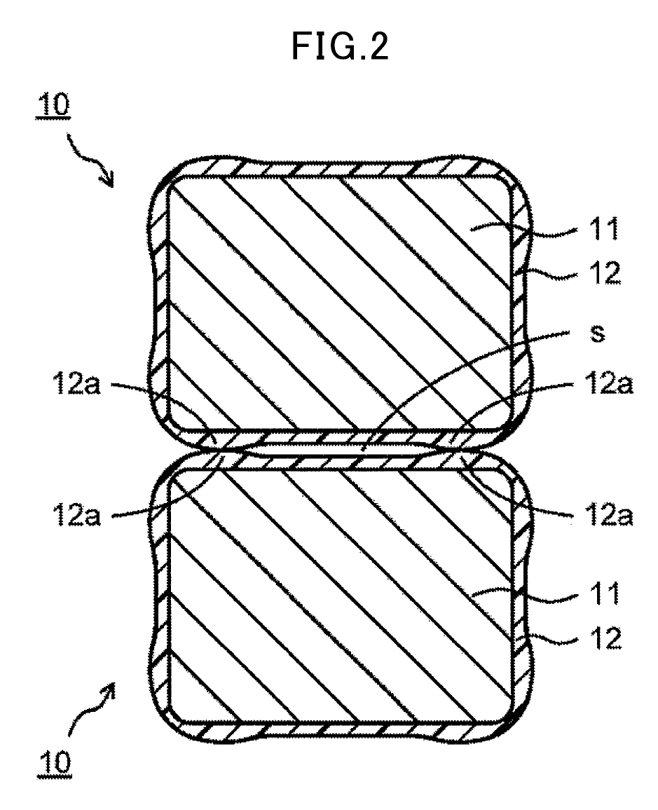

FIG. 1 is a sectional view showing one embodiment of an insulated electrical wiring of the present disclosure. In addition, FIG. 2 is a sectional view showing a laminated state of the insulated electrical wiring shown in FIG. 1.

As shown in FIG. 1, an insulated electrical wiring 10 includes a rectangular conductor 11 having a rectangular section (substantially quadrangular prism shape) and an insulating film 12 arranged around the rectangular conductor 11. As shown in FIG. 2, the insulated electrical wirings 10 are, for example, laminated to form a stator coil or the like of the rotary electric machine. In the following, a direction in which the insulated electrical wirings 10 are laminated (vertical direction in the figure) is referred to as a lamination direction.

[Rectangular conductor]

The rectangular conductor 11 has a rectangular section (first to fourth lateral faces). Each of the first to fourth lateral faces is a substantially flat face. The first and second lateral faces are, for example, arranged in the lamination direction (vertical direction in the figure) and the third and fourth lateral faces are, for example, arranged in a direction perpendicular to the lamination direction (horizontal direction in the figure). That is, the first and second lateral faces and the third and fourth lateral faces are arranged opposed to each other, respectively.

A length in the lamination direction (vertical direction in the figure) is preferably from 0.7 to 3.0 mm. A length in the direction perpendicular to the lamination direction (horizontal direction in the figure) is preferably from 2.0 to 7.0 mm. Each of four corners of the rectangular conductor 11 may or may not have rounds. In a case where each of the four corners has rounds, radius thereof is preferably 0.4 mm or less. The shape of each of the four corners preferably has no rounds because a coil space factor becomes high. The rectangular conductor 11 is made of copper, aluminum, or alloy thereof. The rectangular conductor 11 is preferably made of copper or copper alloy from the point of view of mechanical strength and conductivity. Normally, the rectangular conductor 11 is formed by wire drawing.

### [Insulating Film]

An insulating film 12 has a rectangular frame-like section corresponding to the rectangular section of the rectangular conductor 11. That is, the insulating film 12 has first to fourth areas (first to fourth films) corresponding to the first to fourth lateral faces of the rectangular conductor 11. Among these areas, at least a pair of areas (first and second areas) are arranged so as to hold the rectangular conductor 11 therebetween (for example, arranged in the lamination direction (vertical direction in the figure)).

Each of the first to fourth areas has convex portions 12a at both edge portions (boundaries between first to fourth areas). An intermediate portion is arranged between a pair of the convex portions 12a. Each of the first to fourth areas has an arc shape (substantially curved shape). That is, a thickness becomes gradually smaller from one toward the other of the pair of the convex portions 12a and the thickness becomes gradually large again. Between the pair of the convex portions 12a, for example, a flat portion 12b having a substantially constant thickness may be arranged.

At least the pair of areas (for example, the pair of areas arranged in the lamination direction (vertical direction in the figure)) arranged so as to hold the above rectangular conductor 11 therebetween satisfy the following relation, respectively. That is, a ratio (d₂/d₁) of a thickness (d₂) of the thinnest portion relative to a thickness (d₁) of the thickest portion between apexes of the pair of convex portions 12a arranged at both edge portions is from 0.50 to 0.90.

In a case where the above relation is satisfied (specifically, in a case where the pair of convex portions 12a are provided and the ratio (d₂/d₁) is from 0.50 to 0.90), for example, as shown in FIG. 2, a space S is formed between the insulated electrical wirings 10. Therefore, since varnish is impregnated and cured in such a space S, the insulated electrical wirings 10 are bonded and fixed.

Particularly, when the ratio (d₂/d₁) is from 0.50 to 0.90, the insulated electrical wirings 10 are fixed reliably. As a result, the vibration resistance and shock resistance are improved, and reduction of the coil space factor is suppressed to give satisfactory output characteristics.

That is, when the ratio (d₂/d₁) is larger than 0.90, the space S becomes small. As a result, the content of varnish becomes small, and thus there is a risk that the insulated electrical wirings 10 are not fixed reliably. The ratio (d₂/d₁) is preferably equal to or less than 0.85 from the point of view of the content of varnish and fixation of the insulated electrical wirings 10.

In contrast, when the ratio (d₂/d₁) is less than 0.50, the space S becomes large. As a result, the coil space factor becomes low, and there is a risk that the output characteristics decrease. The ratio (d₂/d₁) is more preferably equal to or more than 0.7 from the point of view of the coil space factor and output characteristics.

Here, the thickness (d₁) of the thickest portion and the thickness (d₂) of the thinnest portion are measured between apexes of the pair of convex portions 12a arranged at both edge portions of one area. Specifically, the thickness is sequentially measured from a position of the apex of the convex portion 12a arranged at one edge portion to a position of the apex of the convex portion 12a arranged at the other edge portion, and the thickness (d₁) of the thickest portion and the thickness (d₂) of the thinnest portion are obtained.

Note that the pair of the convex portions 12a preferably have the same height but may have different heights. When the pair of the convex portions 12a have different heights, the measured value for the higher convex portion 12a becomes the thickness (d₁) of the thickest portion.

In addition, the flat portion 12b preferably has the same height from one edge portion to the other edge portion but may have different heights. When the flat portion 12b has different heights, the central portion is preferably the thinnest. That is, the thickness (d₂) of the thinnest portion is preferably near the center.

The thickness (d₂) of the thinnest portion is preferably from 60 to 200 μm. If the thickness (d₂) of the thinnest portion is 60 μm or more, a starting voltage of partial discharge becomes high. In contrast, if the thickness (d₂) of the thinnest portion is 200 μm or less, the insulating film 12 becomes thin and miniaturization can be achieved. The thickness (d₂) of the thinnest portion is more preferably from 60 to 160 μm.

In the insulating film 12, also for each of the pair of areas arranged in the direction perpendicular to the lamination direction, the pair of convex portions 12a are provided at both edge portions, and a ratio (d₂/d₁) of a thickness (d₂) of the thinnest portion relative to a thickness (d₁) of the thickest portion is preferably from 0.50 to 0.90. That is, in the insulating film 12, for all of four areas, each area has the pair of convex portions 12a at both edge portions, and the ratio (d₂/d₁) of the thickness (d₂) of the thinnest portion relative to the thickness (d₁) of the thickest portion is preferably from 0.50 to 0.90.

In this way, the insulated electrical wirings 10 are fixed reliably in the lamination direction, and the insulated electrical wire 10 and other members are fixed reliably in the direction perpendicular to the lamination direction. Examples of the other members include slots arranged in the stator core of the rotary electric machine.

The insulating film 12 is preferably made of polyimide. The polyimide generally has resistance to oils. Examples of oils include insulating oil, machine oil, engine oil, and transmission oil. Use of polyimide in the insulating film 12 is preferred for the rotary electric machine of a vehicle.

As the polyimide, a first polyimide or second polyimide shown below is particularly preferable. Although any of the first polyimide or second polyimide may be used, the second polyimide is preferably used from the point of view of adhesion.

### (First Polyimide)

The first polyimide can be obtained by reacting an acid component with a diamine component. The acid component is composed of 50-90 mol % of 3,3,4,4-biphenyltetracarboxylic dianhydride (BPDA), 5-20 mol % of 3,3,4,4-benzophenone tetracarboxylic dianhydride (BTDA), and 5-40 mol % of pyromellitic anhydride (PMDA). The diamine component contains 4,4-diaminodiphenyl ether (DDE). According to such a composition, excellent adhesion can be obtained.

The acid component preferably contains 60-70 mol % of 3,3,4,4-biphenyltetracarboxylic dianhydride, 10-15 mol % of 3,3,4,4-benzophenone tetracarboxylic dianhydride, and 25-30 mol % of pyromellitic anhydride from the point of view of adhesion.

The diamine component can use a component other than 4,4-diaminodiphenyl ether in combination (another diamine component). The other diamine component may include aromatic diamine, such as m-phenylenediamine, p-phenylenediamine, 2,4-diaminotoluene, 4,4-diamino-3,3-dimethyl-1,1-biphenyl, 4,4-diamino-3,3-dihydroxy-1,1-biphenyl, 3,4-diaminodiphenyl ether, 3,3-diaminodiphenylsulfone, 4,4-diaminodiphenylsulfone, 4,4-diaminodiphenylsulfide, 2,2-bis (4-aminophenyl) propane, 2,2-bis (4-aminophenyl) hexafluoropropane, 1,3-bis (4-aminophenoxy) benzene, 1,4-bis (4-aminophenoxy) benzene, 4,4-bis (4-aminophenoxy) biphenyl, 2,2-bis [4-(4-aminophenoxy) phenyl] propane, 2,2-bis [4-(4-aminophenoxy) phenyl] hexafluoropropane, bis [4-(3-aminophenoxy) phenyl] sulfone, or bis [4-(4-aminophenoxy) phenyl] sulfone.

The diamine component preferably contains 80 mol % or more of 4,4-diaminodiphenyl ether and more preferably contains 90 mol % or more from the point of view of adhesion. Particularly, the diamine component preferably consists only of 4,4-diaminodiphenyl ether.

A solvent for reacting an acid component with a diamine component may include an aprotic polar solvent, such as 2-pyrolidone, N-methyl-2-pyrolidone (NMP), and N, N-dimethylacetamide (DMAc), or a phenolic solvent, such as phenol, cresol, and xylenol.

When an acid component is made to react with a diamine component, a reaction catalyst, such as amines, imidazoles, and imidazolines, may be used. The reaction catalyst is preferably one that does not inhibit stability of the resin varnish. (Second polyimide)

The second polyimide can be obtained by reacting an acid component with a diamine component. The acid component is composed of 5-70 mol % of 3,3,4,4-biphenyltetracarboxylic dianhydride (BPDA) and 30-95 mol % of pyromellitic anhydride (PMDA). The diamine component contains 4,4-diaminodiphenyl ether (DDE). According to such a composition, excellent adhesion can be obtained.

Note that if the acid component contains a large amount of 3,3,4,4-biphenyltetracarboxylic dianhydride, an imide group ratio of the second polyimide decreases. In this case, a viscosity of film varnish for forming the insulating film 12 becomes low, and the ratio (d₂/d₁) easily becomes small. From the point of view of adjustment of the ratio (d₂/d₁), the acid component preferably contains 20-70 mol % of 3,3,4,4-biphenyltetracarboxylic dianhydride and 30-80 mol % of pyromellitic anhydride, and more preferably contains 55-65 mol % of 3,3,4,4-biphenyltetracarboxylic dianhydride and 35-45 mol % of pyromellitic anhydride.

The diamine component can use a component other than 4,4-diaminodiphenyl ether in combination (another diamine component). The other diamine component may include aromatic diamine, such as m-phenylenediamine, p-phenylenediamine, 2,4-diaminotoluene, 4,4-diamino-3,3-dimethyl-1,1-biphenyl, 4,4-diamino-3,3-dihydroxy-1,1-biphenyl, 3,4-diaminodiphenyl ether, 3,3-diaminodiphenylsulfone, 4,4-diaminodiphenylsulfone, 4,4-diaminodiphenyl sulfide, 2,2-bis (4-aminophenyl) propane, 2,2-bis (4-aminophenyl) hexafluoropropane, 1,3-bis (4-aminophenoxy) benzene, 1,4-bis (4-aminophenoxy) benzene, 4,4-bis (4-aminophenoxy) biphenyl, 2,2-bis [4-(4-aminophenoxy) phenyl] propane, 2,2-bis [4-(4-aminophenoxy) phenyl] hexafluoropropane, bis [4-(3-aminophenoxy) phenyl] sulfone, and bis [4-(4-aminophenoxy) phenyl] sulfone.

The diamine component preferably contains 80 mol % or more of 4,4-diaminodiphenyl ether and more preferably contains 90 mol % or more. Particularly, the diamine component preferably consists only of 4,4-diaminodiphenyl ether.

A solvent for reacting an acid component with a diamine component may include an aprotic polar solvent, such as 2-pyrolidone, N-methyl-2-pyrolidone (NMP), and N, N-dimethylacetamide (DMAc), or a phenolic solvent, such as phenol, cresol, and xylenol.

When an acid component is made to react with a diamine component, a reaction catalyst, such as amines, imidazoles, and imidazolines, may be used. The reaction catalyst is preferably the one that does not inhibit stability of the resin varnish.

The first polyimide and the second polyimide can contain an adhesion improver. Examples of the adhesion improver include thiadiazols, thiazoles, mercaptobenzimidazoles, thiophenols, thiophenes, thiols, tetrazoles, benzimidazoles, butylated melamines, and heterocyclic mercaptans. Note that from the point of view of suppressing adhesion from decreasing due to thermal deterioration during use, it is preferable not to use the adhesion improver.

The insulating film 12 is formed by applying the film varnish that can form the polyimide as described above onto the rectangular conductor 11 and baking it. As the application method, a method for immersing the rectangular conductor 11 in the film varnish is preferable.

On this occasion, the convex portion 12a can be formed and the height thereof can be adjusted by adjusting the viscosity of the film varnish. That is, the ratio (d₂/d₁) can be adjusted by adjusting the viscosity of the film varnish. For example, if the viscosity becomes low, the convex portion 12a becomes high and the ratio (d₂/d₁) becomes small. On the other hand, if the viscosity becomes high, the convex portion 12a becomes low and the ratio (d₂/d₁) becomes large.

To set the ratio (d₂/d₁) within a predetermined range, the viscosity of the film varnish is preferably 1500 mPa·s or more, more preferably 2000 mPa·s or more, and furthermore preferably 3000 mPa·s or more. In addition, the viscosity of the film varnish is preferably 10000 mPa·s or less, more preferably 9000 mPa·s or less, and furthermore preferably 8000 mPa·s or less. Note that the viscosity is measured by using a type B rotary viscosimeter at a temperature of 30° C. In addition, a viscosity (Pa·s) is calculated by the following formula.

Viscosity (Pa·s)=l·k·A/1000

A: factor depending on type of device (2 for type B)

k: factor based on combination of rotational speed and spindle (unit: Pa·s/1000)

1: average of indication values of indicator needle for two measurements

Note that as the insulating film 12, the one in which polyimide and polyamide-imide are laminated may be used. As such, for example, the one in which polyimide, polyamide-imide, and polyimide are sequentially laminated in order from the rectangular conductor 11 can be cited.

Use of polyamide-imide improves the mechanical characteristics. In addition, holding of polyamide-imide with the pair of polyimides suppresses polyamide-imide from deteriorating due to oils. As the polyamide-imide, those shown below can be used. In addition, as the polyimide, those already described above, specifically, the first polyimide and second polyimide can be used.

### (Polyamide-Imide)

As the polyamide-imide, those obtained by reacting an acid component with an isocyanate component containing 2,4-diphenylmethane diisocyanate (2,4-MDI) and dimer acid diisocyanate (DDI) is preferable.

Use of 2,4-diphenylmethane diisocyanate and dimer acid diisocyanate as the isocyanate component provides satisfactory flexibility. As the isocyanate component, in addition to 2,4-diphenylmethane diisocyanate and dimer acid diisocyanate, components other than these can be used in combination.

Components (other components) other than 2,4-diphenylmethane diisocyanate and dimer acid diisocyanate include 4,4-diphenyl methane diisocyanate (4,4-MDI), 3,4-diphenylmethane diisocyanate, 3,3-diphenyl methane diisocyanate, 2,3-diphenyl methane diisocyanate, 2,2-diphenyl methane diisocyanate, in addition, tolylene diisocyanate (TDI), diphenyl ether diisocyanate, naphthalene diisocyanate, phenylene diisocyanate, xylylene diisocyanate, diphenyl sulfone diisocyanate, bitolylene diisocyanate, dianisidine diisocyanate, and isomers thereof. In addition, the other components include aliphatic diisocyanates, such as hexamethylene diisocyanate, isophorone diisocyanate, methylenedicyclohexyl diisocyanate, xylylene diisocyanate, and cyclohexane diisocyanate, polyfunctional isocyanate such as triphenylmethane triisocyanate, polymeric isocyanate, or multimeric complex such as tolylene diisocyanate.

The isocyanate component preferably contains 10-70 mol % of 2,4-diphenylmethane diisocyanate and dimer acid diisocyanate in total and more preferably contains 30-60 mol %. The acid components may include aromatic tetracarboxylic acid dianhydride and its isomer, such as trimellitic acid anhydride (TMA), pyromellitic dianhydride (PMDA), benzophenone tetracarboxylic dianhydride (BTDA), biphenyltetracarboxylic dianhydride, diphenyl sulphone-tetracarboxylic acid dianhaydride (DSDA), and oxydiphthalic dianhydride, alicyclic tetracarboxylic acid dianhydride, such as butane tetracarboxylic acid dianhydride, and 5-(2,5-dioxotetrahydro-3-furanyl)-3-methyl-3-cyclohexene-1,2-dicarboxylic anhydride, and tricarboxylic acid and its isomer, such as trimesic acid, and tris(2-carboxyethyl)isocyanurate (CIC acid). Among these, trimellitic acid anhydride (TMA) that is inexpensive and excellent in safety is preferable.

In addition to the isocyanate component and acid component, polycarboxylic acid may be added. The polycarboxylic acid includes aromatic dicarboxylic acids, such as terephthalic acid and isophthalic acid, aromatic tricarboxylic acids, such as trimellitic acid and hemimellitic acid, and aliphatic polycarboxylic acids, such as dimer acid.

The solvent for reacting an isocyanate component with an acid component may include an aprotic polar solvent, such as 2-pyrolidone, N-methyl-2-pyrolidone (NMP), and N, N-dimethylacetamide (DMAc), and a phenolic solvent, such as phenol, cresol, and xylenol. When an isocyanate component is made to react with an acid component, a reaction catalyst, such as amines, imidazoles, and imidazolines, may be used. The reaction catalyst is preferably the one that does not inhibit stability.

The insulated electrical wire 10 has been described above, however, as at least the pair of areas in which the convex portion 12a is arranged at both edge portions and which satisfy the ratio (d₂/d₁) of 0.50 to 0.90 are not necessarily limited to the lamination direction but may be, for example, in the direction perpendicular to the lamination direction.

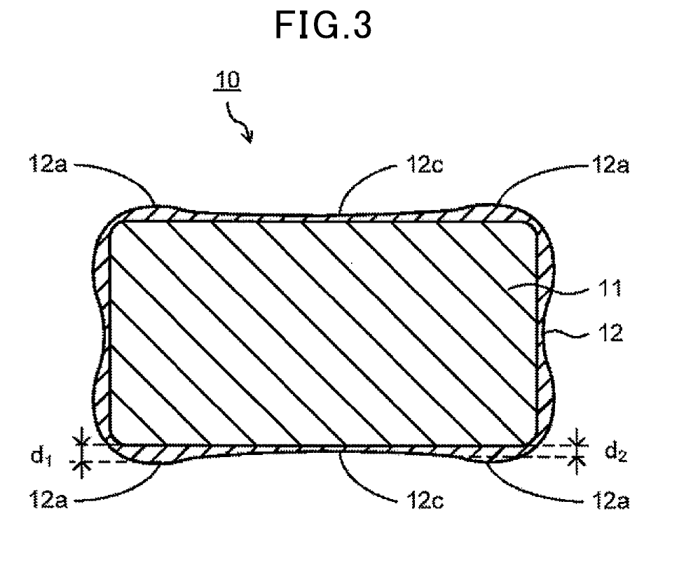

In addition, as shown in FIG. 3, the rectangular conductor 11 does not necessarily have a section close to a square but may have a rectangular section, and also the insulating film 12 does not necessarily have a frame-like section close to a square but may have a rectangular frame-like section. In addition, the portion between the pair of convex portions 12a is not necessarily the flat portion 12b having an almost constant thickness but may be a concave portion 12c having the smallest thickness at the central portion.

### <Rotary Electric Machine>

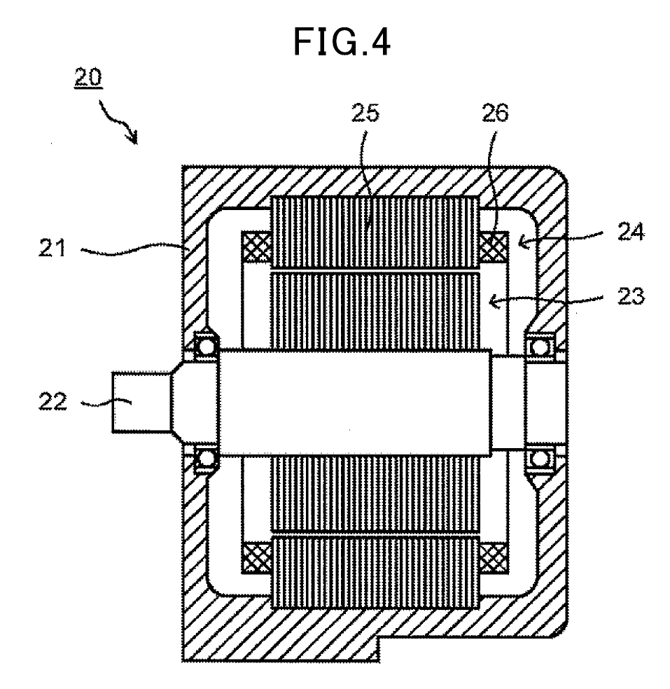

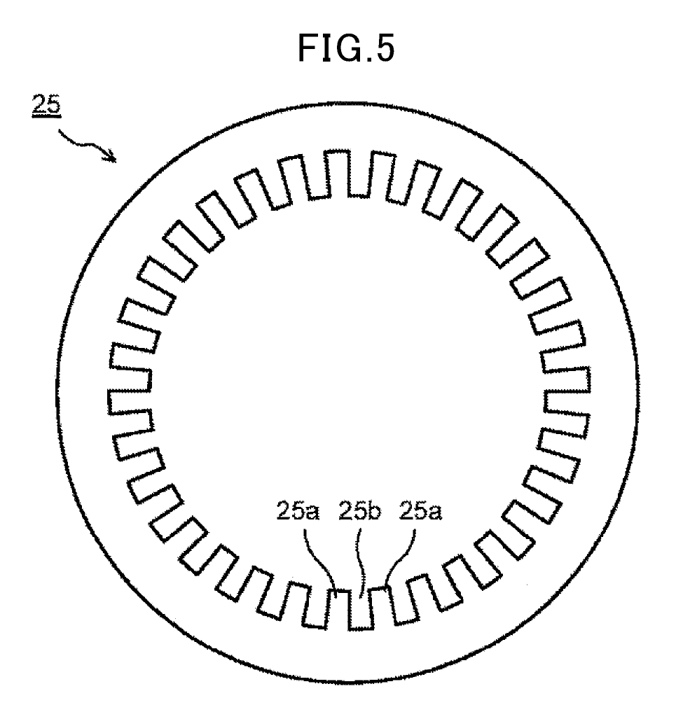

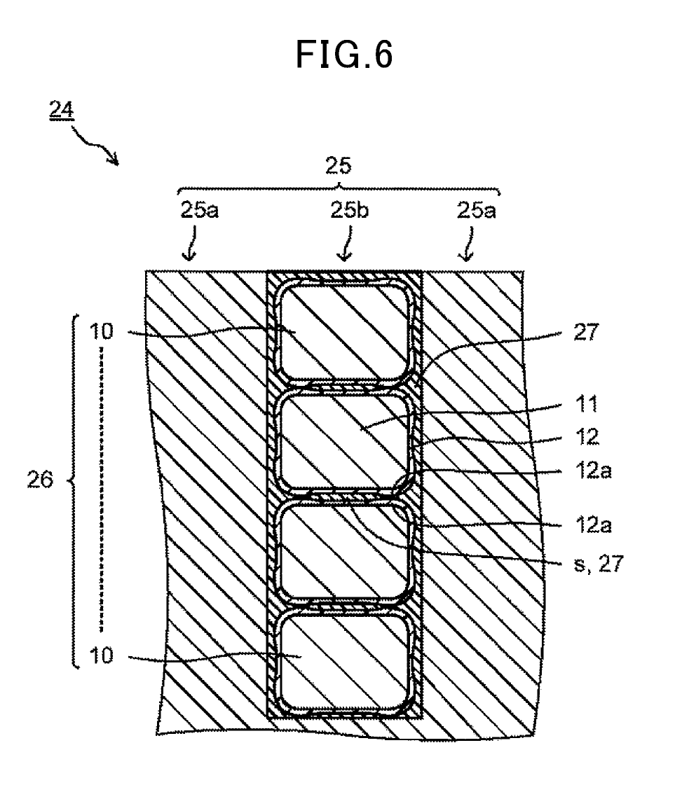

FIG. 4 is a sectional view showing an embodiment of a rotary electric machine using the insulated electrical wire 10. FIG. 5 is a plan view showing a stator core of the rotary electric machine shown in FIG. 4. FIG. 6 is a sectional view of the stator core and stator coil of the rotary electric machine shown in FIG. 4. Note that in FIG. 6, the horizontal direction in the figure is a circumferential direction and the vertical direction in the figure is an inside-outside direction of the stator core, and the upper side in the figure is an inside of the stator core and the lower side in the figure is an outside of the stator core.

As shown in FIG. 4, the rotary electric machine 20 has a rotor shaft 22 which is an output shaft near the center of a case 21. A rotor 23 is fixed to the rotor shaft 22. A stator 24 is arranged around the rotor 23.

The rotor 23 is composed of a rotor core formed of laminated magnetic steel sheets and a plurality of permanent magnets arranged in the rotor core, for example. The rotor 23 generates rotational energy by a rotating magnetic field received from the stator 24.

The stator 24 has a stator core 25 formed of laminated magnetic steel sheets and a stator coil 26 arranged in the stator core 25, for example. As shown in FIG. 5, the stator core 25 has an annular shape as a whole. A plurality of teeth 25a are arranged in a circumferential direction inside the stator core 25. In addition, a slot 25b (space) is arranged between the teeth 25a.

As shown in FIG. 6, a part of the stator coil 26 is housed in the slot 25b. The stator coil 26, for example, has the insulated electrical wirings 10 sequentially laminated from the bottom of the slot 25b. The stator 24 is subjected to varnish treatment. As a result, varnish 27 is impregnated into a space between the slot 25b and the stator coil 26 and cured. Further, the varnish 27 is impregnated into a space S between the insulated electrical wirings 10 of the stator coil 26 and cured.

The varnish 27 fixes the slot 25b and the stator coil 26 and also fixes the insulated electrical wirings 10 of the stator coil 26. This improves vibration resistance and shock resistance. In addition, infiltration of moisture, dust, water vapor, gas, and other harmful substances in the atmosphere are suppressed from infiltrating. Further, corrosion of a metallic portion is suppressed from occurring. As such a varnish 27, various synthetic resins can be used.

As already described above, the insulated electrical wire 10 includes the rectangular conductor 11 and the insulating film 12 arranged around the rectangular conductor 11. In addition, the insulating film 12 has at least the pair of areas (films) arranged so as to hold the rectangular conductor 11 therebetween. The pair of areas each have the pair of convex portions 12a at both edge portions, and the ratio (d₂/d₁) between apexes of the pair of convex portions is from 0.50 to 0.90. Such a pair of areas, for example, include the pair of areas arranged in the lamination direction (for example, vertical direction in the figure) of the insulated electrical wire 10.

According to the rotary electric machine 20, the varnish 27 is impregnated into the space S formed between the insulated electrical wirings 10 and cured, and thereby the insulated electrical wirings 10 are bonded and fixed. Particularly, when the ratio (d₂/d₁) is from 0.50 to 0.90, a size of the space S becomes optimal, that is, a content of the varnish 27 becomes optimal, and the insulated electrical wirings 10 are reliably bonded and fixed. This improves the vibration resistance and shock resistance of the rotary electric machine 20. Further, the output characteristics also become satisfactory because the coil space factor is maintained.

The rotary electric machine 20 is excellent in vibration resistance and shock resistance and thus is preferably used for a vehicle. The vehicle includes a hybrid vehicle and an electric vehicle. The rotary electric machines 20 may be used for any of power generators and electric motors in these vehicles but are preferably used as drive motors.

The rotary electric machine 20, particularly the stator 24, can be produced as follows. First, the stator coil 26 composed of the insulated electrical wire 10 is attached to the slot 25b of the stator core 25 to produce a coil attachment unit. After that, the coil attachment unit is subjected to varnish treatment.

The varnish treatment can be performed as follows. First, the coil attachment unit is arranged so that its central axis is horizontal. Then, while the coil attachment unit is rotated around the central axis, the varnish 27 that is a varnish for impregnation is supplied to the inside of the coil attachment unit. Thereby, by gravity and centrifugal force, the varnish 27 is impregnated into a space between the slot 25b and the stator coil 26, and also the varnish 27 is impregnated into the space S between the insulated electrical wirings 10 forming the stator coil 26. After the impregnation, the varnish 27 is cured by heating. The heating may be performed by feeding current through the stator coil 26 or by placing the coil attachment unit in a heating furnace.

Although an embodiment of the present disclosure has been described as above, the present disclosure is not limited directly to the above embodiment, and the constituent elements can be modified and embodied within a range not deviating from the gist in the implementation phase.

### EXAMPLES

In the following, the present disclosure will be described specifically by way of examples, however, the present disclosure is not limited to the examples at all.

### [Film Varnish]

Polyimide resin varnish as the film varnish was produced as follows. Note that the film varnish is used for formation of an insulating film in an insulated electrical wire. First, as an acid component, 0.5 mol of 3,3,4,4-biphenyl tetracarboxylic acid dianhydride (BPDA) and 0.5 mol of pyromellitic anhydride (PMDA), and as a diamine component, 1.02 mol of 4,4-diaminodiphenyl ether (DDE) were introduced into a flask including an agitator, a nitrogen inflow pipe, and a temperature control device. After that, as needed, N-methyl-2-pyrrolidone as a solvent and a thickening agent were introduced and reacted for two hours under a nitrogen atmosphere. Thereby, the polyimide resin varnish as the film varnish was produced.

Note that a plurality of kinds of film varnish different in viscosity were produced as shown in Table 1. The viscosity was adjusted by additive amounts of the solvent, thickening agent, and the like. The viscosity was measured by a type B rotary viscosimeter at 30° C.

### Examples 1 to 3

As the insulated electrical wire, as shown in FIG. 1, one that has an insulating film formed on the rectangular conductor and has a convex portion at both edge portions of each area of the insulating film was produced. That is, the insulating film has a convex portion at all of both edge portions of four areas.

The rectangular conductor is made of copper and has a rectangular section. In addition, a length in the lamination direction (vertical direction in the figure) is 1.8 mm and a length in a direction perpendicular to this (horizontal direction in the figure) is 2.6 mm.

In the insulating film, each of the pair of areas (films) arranged in the lamination direction has a ratio (d₂/d₁) as shown in Table 1. Note that each of the pair of areas arranged in a direction perpendicular to the lamination direction also has the almost same ratio (d₂/d₁) as the ratio (d₂/d₁) shown in Table 1.

After the rectangular conductor was immersed into the film varnish and applied with the varnish, the film varnish applied to the rectangular conductor was baked to produce the insulated electrical wire. The ratio (d₂/d₁) was adjusted by viscosity of the film varnish.

### Comparative Example 1

An insulated electrical wire was produced as in Example 1 except that the ratio (d₂/d₁) was changed as shown in Table 1. The ratio (d₂/d₁) was adjusted by viscosity of the film varnish.

### Comparative Example 2

An insulated electrical wire having a flat insulating film on the rectangular conductor was produced. That is, the insulating film has no convex portion. Note that the flat insulating film does not have the thickest portion and the thinnest portion, however, for convenience sake, in Table. 1, the ratio (d₂/d₁) was set to 1.0 assuming that the thickness (d₁) of the thickest portion is equal to the thickness (d₂) of the thinnest portion. The flat insulating film was formed by adjusting the viscosity of film varnish.

Next, the stator of the rotary electric machine was produced by using the insulated electrical wire of Examples 1 to 3 and Comparative examples 1 to 2. Specifically, first, the stator coil composed of the insulated electrical wire of Examples 1 to 3 or Comparative examples 1 to 2 was attached to the slot of the stator core to produce the coil attachment unit. On this occasion, as shown in FIG. 6, the insulated electrical wirings were sequentially laminated from the bottom of the slot.

After that, the coil attachment unit was subjected to varnish treatment. First, the coil attachment unit was arranged so that its central axis became horizontal. Then, while the coil attachment unit was rotated around the central axis, the varnish for impregnation was supplied to inside thereof. By gravity and centrifugal force, the varnish for impregnation was impregnated into a space between the slot and the stator coil, and also the varnish for impregnation was impregnated into a space between the insulated electrical wirings forming the stator coil. On this occasion, polyimide resin varnish was used as the varnish for impregnation. After the impregnation, the varnish was cured by heating.

The stators thus produced were evaluated as follows.

### [Vibration Resistance]

The vibration resistance was evaluated as follows. First, cooling/heating cycling and vibration were applied to the stator and a durability test was conducted. After the durability test, a portion protruding from the slot of the stator core in the stator coil was cut and removed.

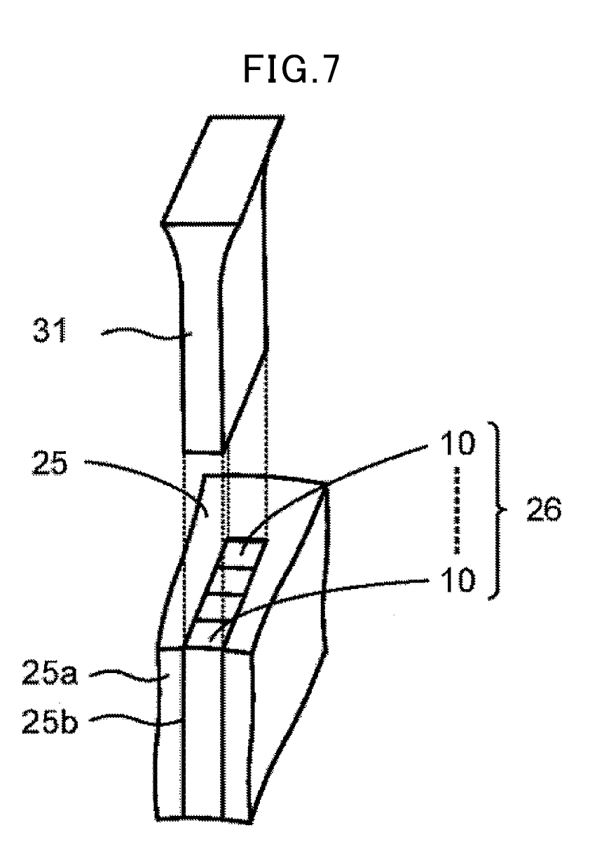

For such a stator from which the protruding portion of the stator coil was cut and removed, as shown in FIG. 7, extrusion load was measured by applying a load to the stator coil 26 housed in the slot 25b of the stator core 25 so as to push an extrusion member 31 to the stator coil 26 from outside in the axial direction. The maximum value of extrusion load at this time was defined as a fixing strength. The fixing strength of Comparative example 2 having no convex portion in the insulating film was evaluated as □b□(standard), and the example having improved fixing strength in the table was evaluated as □a□considering that the vibration resistance is satisfactory.

### (Coil Space Factor)

As the coil space factor, (sectional area of rectangular conductor in slot)/(sectional area of slot)×100 [%] was obtained. Note that if the coil space factor is equal to or more than 50%, the output characteristics of the rotary electric machine are satisfactory.

### (Overall Evaluation)

The overall evaluation of the example which was evaluated as □a∇in vibration resistance and had the coil space factor of 50% or more was indicated by □A□considering that the reliability and output characteristics were satisfactory, and the overall evaluation of the example which did not satisfy the above conditions was indicated by □B□considering that the reliability or output characteristics were not satisfactory.

TABLE 1

| | | | | COMPARATIVE | |
|---|---|---|---|---|---|
| | EXAMPLE | | | EXAMPLE | |
| | 1 | 2 | 3 | 1 | 2 |
| VISCOSITY OF | 3000 | 5000 | 8000 | 500 | 20000 |
| FILM VARNISH | | | | | |
| [mPa s] | | | | | |
| d2/d1 | 0.5 | 0.7 | 0.9 | 0.3 | 1.0 |
| VIBRATION | a | a | a | a | b |
| RESISTANCE | | | | | |
| COIL SPACE | 60 | 70 | 80 | 40 | 90 |
| FACTOR [%] | | | | | |
| EVALUATION | A | A | A | B | B |

In a case where the ratio (d₂/d₁) is from 0.50 to 0.90 like the insulated electrical wirings of Examples 1 to 3, the insulated electrical wire having satisfactory vibration resistance and coil space factor can be produced. On the other hand, in a case where the ratio (d₂/d₁) exceeds 0.90 like the insulated electrical wire of Comparative example 2, satisfactory vibration resistance cannot be obtained. In addition, in a case where the ratio (d₂/d₁) is less than 0.50 like the insulated electrical wire of Comparative example 1, the coil space factor is low and therefore the output characteristics are not satisfactory.

What is claimed is:

1. An insulated electrical wire, comprising:
a conductor having a first lateral face and a second lateral face which are facing towards each other; and
a first insulating film and a second insulating film which are arranged on the first lateral face and the second lateral face, respectively, and each of which has a pair of convex portions and an intermediate portion arranged between the pair of convex portions, wherein
a ratio of a thickness of the intermediate portion relative to a thickness of the convex portion of each of the first and second insulating films is from 0.50 to 0.90.

2. The insulated electrical wire according to claim 1, wherein
the conductor further has a third and a fourth lateral faces which are opposed to each other,
the insulated electrical wire further includes a third insulating film and a fourth insulating film which are arranged on the third lateral face and the fourth lateral face, respectively, and each of which has a pair of convex portions and an intermediate portion arranged between the pair of convex portions, and
a ratio of a thickness of the intermediate portion relative to a thickness of the convex portion of each of the first to fourth insulating films is from 0.50 to 0.90.

3. The insulated electrical wire according to claim 2, wherein
the conductor has a substantially quadrangular prism shape.

4. The insulated electrical wire according to claim 2, wherein
the first to fourth insulating films each have a pair of edges facing each other and are connected by these edges.

5. The insulated electrical wire according to claim 4, wherein
the pair of convex portions are arranged near the pair of edges.

6. The insulated electrical wire according to claim 1, wherein
each of the first and second insulating films has a polyimide obtained by reacting a diamine component with an acid component containing 5-70 mol % of a biphenyltetracarboxylic acid anhydride unit and 30-95 mol % of a pyromellitic acid anhydride unit.

7. The insulated electrical wire according to claim 6, wherein
each of the first and second insulating films has a polyimide obtained by reacting an acid component comprising 5-70 mol % of 3,3,4,4-biphenyltetracarboxylic dianhydride and 30-95 mol % of pyromellitic anhydride with a diamine component comprising 4,4-diaminodiphenyl ether.

8. The insulated electrical wire according to claim 7, wherein
each of the first and second insulating films has a polyimide obtained by reacting an acid component comprising 55-65 mol % of 3,34,4-biphenyltetracarboxylic dianhydride and 35-45 mol % of pyromellitic anhydride with a diamine component comprising 4,4-diaminodiphenyl ether.

9. A coil comprising an insulated electrical wire according to claim 1.

10. A rotary electric machine comprising an insulated electrical wire according to claim 1.

11. The rotary electric machine according to claim 10, comprising:
a rotor shaft;
a rotor attached to the rotor shaft;
a stator core arranged around the rotor and having a plurality of slots in a circumferential direction;
a stator coil at least part of which is arranged in the slot; and
a varnish impregnated in the slot, wherein
the stator coil has a first and a second insulated wiring laminated in the slot,
an intermediate portion of a first insulating film of the first insulated wiring and an intermediate portion of a second insulating film of the second insulated wiring are arranged facing each other, and
at least part of the varnish is arranged between the intermediate portions facing each other.

12. The rotary electric machine according to claim 11, wherein
the rotary electric machine is a drive motor of a hybrid vehicle or an electric vehicle.
